(19) United States
(12) Patent Application Publication
(10) Pub. No.: US 2002/0053562 A1
(43) Pub. Date: May 9, 2002

(54) Heating element on an aluminum substrate for household electric appliance

(75) Inventors: Pascal Cuillery, Faverges (FR); Jean-Louis Compeau, St. Quentin Fallavier (FR)

Correspondence Address: BROWDY AND NEIMARK, P.L.L.C., 624 NINTH STREET, NW, SUITE 300, WASHINGTON, DC, 20001-5303, US

(73) Assignee: SEB S.A., Ecully (FR)

(21) Appl. No.: 10/022,727

(22) Filed: Dec. 20, 2001

Related U.S. Application Data
(63) Continuation of application No. PCT/FR01/01140, filed on Apr. 12, 2001.

(30) Foreign Application Priority Data
Apr. 21, 2000 (FR) 00/05191

(51) Int. Cl. H05B 3/26; D06F 75/00

(52) U.S. Cl. 219/254; 219/548; 38/82

(57) ABSTRACT

A heating element for a soleplate of an iron, composed of: a substrate constituted by a plate containing aluminum; an insulator covering one surface of the plate; and a heating circuit carried by the insulator, wherein the insulator includes an anodized oxide layer having a thickness between 10 and 200 microns and resistant to abrupt temperature variations of the plate.

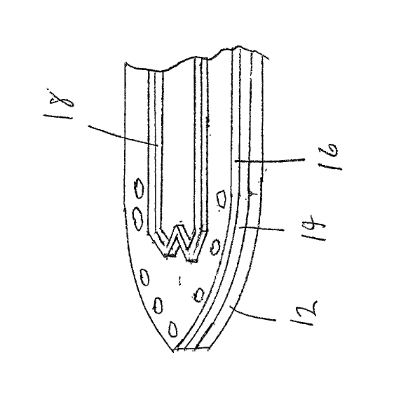

This is a continuation of International application No. PCT/FR01/01140, filed Apr. 12, 2001.

### BACKGROUND OF THE INVENTION

The present invention concerns heating elements for pressing irons.

Pressing ions are composed in a conventional manner of a casing forming a handle generally of plastic material and a hot metal soleplate that is applied to the linen to be ironed. The soleplate of modern irons is composed of a metallic flat lower plate heated by an upper molded body made of aluminum, this body being applied to the internal face of the flat plate and having a tubular heating element. For reasons of weight, size and economy, it has been sought to avoid using a molded body of aluminum and to apply a heating element directly to the internal face of the flat plate of the soleplate of the iron.

Thus, the patent EP555159 is known in which the heating element is a sandwich structure adhering to the soleplate. But this structure requires fabrication times and precautions that lead to an insufficiently economical production.

Plates of steel that are enameled on their internal face on, which is disposed a circuit composed of a thin layer or a silkscreen printed circuit, are known. But this process requires the use of vitreous compositions that are sufficiently insulating to withstand the voltage of the electric utility power supply. This type of enamel is deposited at a high temperature that is incompatible with a substrate of aluminum one the one hand and on the other hand the differential contractions after firing of this type of enamel and of the aluminum substrate create stresses that a flat plate of the soleplate of the iron cannot withstand without deformation.

There is known patent FR1584094 which describes a circuit deposited on a substrate of anodized aluminum. But this form of construction where the aluminum layer only has a thickness of several microns is not adapted to a circuit working at the voltages provided in the home. Moreover, their use is limited to temperatures lower than those of a soleplate of an iron.

The patent EP120119 describes an aluminum substrate provided to receive a deposited electric circuit. A thick anodized layer of aluminum assures, with a silicic seal, electric insulation. But if this substrate can receive an electric or electronic circuit, there is no indication that permits one to think that it is adapted to withstand temperatures as high as those experienced by a soleplate of an iron.

The patent EP058023 also describes a sealing treatment of a substrate of anodized aluminum. The alumina layer is sealed by a polymerized organometallic product, for example by heating. But the obligatory sealing treatment to obtain a good dielectric quality does not constitute a redundant security and does not presume a resistance to the it thermal shocks encountered by a pressing iron.

The patent FR2763780 describes a process for fabrication of printed circuits on an aluminum substrate where a thick layer of alumina is formed on the surface to serve as an insulator and can withstand high temperatures without the occurrence of defects. Sealing of the pores is not obligatory. However, if the circuit can function when the substrate is raised to high temperature, it is especially adapted to support the implantation of integrated circuits or modules. These components, which the support contributes to cooling, do not by a large measure have the power and instantaneous temperature variations of a soleplate of an iron.

The document U.S. Pat. No. 3,805,023 describes a heating element having a substrate of an anodized aluminum. The alumina layer obtained in a bath of weak acid prevents contact with the substrate and constitutes an electric barrier, while the exterior of the layer is porous. In the pores there is deposited a light-sensitive product containing a precious metal that serves, after irradiation through a negative and development, as a catalyst for chemical deposition of the conductive strip of nickel.

Utilization for a pressing iron is not in any way cited. A priori, the resistive strips are deposited in place of the catalyst in the pores of the alumina layer. A priori, external pores are entirely counterindicated for a soleplate By of a steam pressing iron working in a moist environment.

### BRIEF SUMMARY OF THE INVENTION

The present invention provides a novel heating element for a soleplate of a pressing iron, this heating element being light, compact and economical to fabricate.

The heating element according to the invention is mounted on the soleplate of a pressing iron, the soleplate being composed of, or including, a substrate constituted by a thin plate of pure aluminum, or aluminum alloyed with silicon, or aluminum alloyed with magnesium, and the heating element includes an insulator that covers the substrate and a heating circuit disposed on the insulator, wherein the insulator is an anodized oxide layer with a thickness between 10 and 200 microns able to withstand abrupt temperature variations of the plate.

The use of aluminum permits all of the advantages of this metal to be obtained, in particular as concerns the temperature distribution across the soleplate. Aluminum, whether pure or alloyed with silicon having practically no magnesium, is in addition easily enameled. Advantageously, for good heat distribution, the substrate of the heating element covers a large part of the internal surface of the soleplate of the iron, allowing the dissipated power to be increased.

Anodization provides the benefits of a natural insulator adherent to the support and whose expansion is compatible with the latter.

Preferably, the oxide layer is of the type of that which is obtained by an anodic oxidization performed in a solution of an acid having a low electric conductivity, with a current density between 1 and 5 A/dm² at a stabilized temperature.

The utilization of oxidization in an acid solution having a low electric conductivity similar to that described in the patent FR2763780 but applied to a household electric appliance heating element, permits the attainment in a surprising manner of a good ability to withstand temperature variations and pulling forces.

In addition, numerous laboratory tests have proven the good durability of this insulation during tests in which the soleplate of the iron is subjected to numerous abrupt occurrences of cooling on a moistened felt, tests substantially representative of a hot iron soleplate applied to a damp cloth used for ironing.

In a preferred version, the substrate of the heating element is an iron soleplate enameled prior to anodization on its outer face intended to be in connect with the fabrics, this enameling performed at a temperature that relieves stresses in the metal.

Anodization requires a stress relief treatment of the metal. When enameling the soleplate before anodization, costs for this stress relief treatment are saved. Preferably, the enamel is protected from corrosion by the anodization baths by a peelable protective varnish.

Preferably, the pores of the oxide layer are filled with another metal oxide obtained by decomposition of a polymerizable organometallic product, such as a silane, an organic derivative of titanium, or zirconium, or germanium, or tin.

Although this filling is not indispensable with all types of oxide layers, it provides a supplementary operating reliability.

In another version, the surface of the oxide layer is impregnated with a temperature resistant organic polymerizable product such as a polyester or a polyimide.

The other possibility is easier to employ and requires a lower curing temperature.

In a preferred version, the conductive heating circuits are pastes that are silkscreened and then baked.

In another embodiment of a heating element for a soleplate, the heating element is formed on an aluminum substrate that is brazed onto the interior face of the iron soleplate at a temperature which permits firing or baking of the circuits.

This permits the attainment of soleplates having a stainless steel face in contact with the fabrics, this face providing a good distribution of heat across the surface.

The brazing is effectuated when the circuits are freshly deposited, which reduces the cost of firing or baking the circuits.

In another version, circuits of nickel are deposited on the dense alumina layer by a chemical process.

One can utilize any known process for depositing an adherent conductive or semi-conductive layer serving as a heating circuit. It is preferred to utilize known processes that consist of metallizing the entire surface then, by utilizing a photosensitive masking resin, producing the circuits by attacking the parts of this surface which are not to be conductive. The advantage is that this type of process essentially only requires equipment compatible with the fabrication of printed circuits.

The invention will be better understood from the following description.

### BRIEF DESCRIPTION OF THE DRAWING

The sole FIGURE is a perspective view of a portion of an iron soleplate equipped with a heating element structure according to the invention.

### DETAILED DESCRIPTION OF THE INVENTION

The FIGURE shows one embodiment of the invention composed of a substrate 12, an insulating layer 14, an optional supplementary insulation layer 16 and a resistive heating circuit, or path, 18 deposited on layer 16.

In a preferred embodiment of the invention, substrate 12 constitutes the soleplate of an iron which is a flat aluminum plate with rounded edges to facilitate sliding on materials to be ironed. The soleplate is stress relieved by a thermal treatment, by heating to 400° C., then degreased, scoured and carefully cleaned.

An oxide layer 14 obtained by anodic oxidation in a solution of an acid having a low electric conductivity is deposited by an electrolytic process on the internal face of the iron of the soleplate. When the deposit obtained cannot serve as a layer for attaching a deposit that provides good ironing qualities to the external face intended to come in contact with the fabric being ironed, this face is masked by conventional galvanoplasty means.

A sufficient oxide insulation layer is obtained by the use of solutions of oxalic, citric, lactic or tartaric acid with a current density of 1-5 A/dm² through the soleplate.

In a preferred version, the insulation produced by the oxide layer is reinforced by optional supplementary insulation 16 for added security.

The supplementary insulation layer is, according to one example, of a siliceous nature. It can be obtained by thermal decomposition of a silane deposited in the surface of the oxide.

In a second version, the supplementary insulation is an oxide or a combination of oxides of metals such as titanium, zirconium, germanium, or tin. It can be obtained by thermal decomposition of known precursors of these metals.

In a third version, the supplementary insulation is a layer of glass having a low melting point, such as the glasses that are utilized to produce hybrid circuits. This layer can be obtained for example by silkscreening of a 7082 paste from the Metech Company and firing at 500° C. on the oxide layer.

The electric circuit comprises resistive heating circuit 18 deposited on the oxide layer 14, or 16 if provided. Preferably, these circuits are pastes or inks deposited by silkscreening and made conductive after firing or baking. One can for example utilize a polyimide paste loaded with silver, marketed by the Protavic Company with the product designation CM3321E, which polymerizes in one hour at 150° C. followed by one hour at 275° C.

Advantageously, a polyimide film (not separately shown) covers the oxide surface 14 or 16 and its heating circuit. This protective film prevents the assembly from being sensitive to moisture. It is obtained for example by silkscreen deposition of IM891 paste of the Protavic Company and polymerization on the circuit.

In the simplest version, the face of the soleplate that is located at the exterior of the iron to come directly in contact with fabric to be ironed is simply cleaned or polished by a mechanical brushing.

In an improved form of construction, the soleplate of the iron is a flat plate with edges that are rounded in order that they are more gentle, made of aluminum alloyed with silicon, with a magnesium content of less than 0.01%. This plate is provided with an enamel layer 20 on its face that will be the exterior face of the iron, enamel being applied at a temperature that anneals and stress relieves the aluminum. It is thus not necessary to perform a stress relief treatment prior to the anodization. The enameling gives good ironing characteristics to the soleplate. Preferably, the enamel is protected at least during the subsequent anodization by a peelable protective film (not shown). The soleplate has on its internal, or upper, face insulation and a heating circuit as already described.

When the user irons with an iron equipped with a soleplate according to the invention, the resistive heating circuit dissipates into the aluminum a substantial quantity of power, which can be up to 2 kW for a soleplate having a surface area of around 2 dm². Aluminum has the advantage of distributing heat well over its entire surface. Moreover, the soleplate undergoes heating to the selected temperature, which can be greater than 250° C. and can be brought in contact with linen that is moist, and even soaked. Severe durability tests show a good quality of the soleplate according to the invention.

According to another form of construction, the substrate of the heating element is a flat plate of aluminum, rather than a soleplate, which is stress relieved and which receives an oxide layer 14 obtained by anodic oxidation in a solution of an acid of low electric conductivity, such as for example the proceeding ones. In the same manner, the oxide layer can receive if needed supplementary insulation 16. Then the circuits are deposited and fired, as needed.

The heating element thus obtained is then cemented on the interior, or upper, face of an iron soleplate constituted by a thin plate of aluminum that is enameled on its external, or lower, face. Advantageously, use is made of a silicon adhesive compatible with the temperatures of utilization of the soleplate. This assembly has the advantageous of being compatible with that of existing iron products having a heating body cemented to a soleplate.

In another form of construction, the substrate of the heating element is a flat plate of aluminum that is stress relieved and that received an oxide layer 14 obtained by anodic oxidation in a solution of an acid having a low electric conductivity, as in the proceeding examples. In the same manner, the oxide layer can receive as needed a supplementary insulation 16, before depositing the circuit 18.

The heating element obtained is brazed on the interior face of a soleplate of an iron constituted by a thin plate of stainless steel. Advantageously, use can be made of a brazing compound melting at temperature that assures firing of the deposited circuits and/or polymerization of the protective layer, rendering the operation more economical. This operation is made possible by rigorous control of the atmosphere in which it occurs.

In a different version, the heating element obtained is fixed on the interior face of a soleplate of an iron, the soleplate being constituted by a thin plate of stainless steel whose exterior edges are rolled in order to come to bear on the heating element and to retain it in a continuous manner. Thermal transfer between the heating element and the soleplate can be assured by a thin layer of heat resistant conductive adhesive, such as silicone adhesive (not shown).

One thus obtains a soleplate which has the same advantages as that of the proceeding example but with another presentation.

In another version, the soleplate of the iron is a flat plate having edges that are rounded in order to be more gentle, made of aluminum alloyed with silicon, with the magnesium content being less than 0.01%. This plate is enameled on its face that is external to the iron at a temperature which anneals and stress relieves the aluminum. It is thus not necessary to perform a separate stress relief treatment prior to the anodization. The enameling gives good ironing characteristics to the soleplate. Preferably, the enamel is protected at least during the anodization by a peelable protective film. The soleplate comprises on its internal face an oxide insulating layer similar to that of the proceeding examples.

On this insulating layer, which is preferably not sealed or is incompletely sealed, a nickel circuit is deposited. To do this, the surface is sensitized by a solution containing palladium chloride or a commercial precursor distributed, for example, by the SHIPLEY Company. The surface is then soaked in a metallization bath comprising nickel sulfate and reducing agents, and is covered with nickel. The surface is then masked with a photosensitive resin, exposed to ultraviolet light through a pattern that reproduces the layout of the desired circuit, and developed by a sodic bath to remove the parts exposed through the mask. The free surface of nickel is then attacked, for example, by a solution of iron perchloride, which leaves only the heating circuit. The residue of masking resin is removed with acetone. These operations, which are compatible with printed circuit fabrication equipment, are conducted according to rules known in the art with the necessary precautions and intermediate rinsings.

Connections are then brazed to the heating circuit by known means.

In comparison with circuits obtained by silkscreening, the circuits obtained by chemical deposition of nickel do not require firing.

The application of this invention is essentially provided for the field of pressing irons, but one can however, envision applying it in an analogous manner, with several obvious adaptions, to the external face of a bottom of a bowl provided for heating water in a boiler or oil in fryer. All processing parameters not specifically set forth herein can be readily determined by those skilled in the art based on principles that are already known in the art.

This application relates to subject matter disclosed in French Application number 00 05191, filed on Apr. 21, 2000, and International Application number PCT/FR01/01140, filed Apr. 12, 2001, the disclosures of which are incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the up phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A heating element for a soleplate of an iron, comprising: a substrate constituted by a plate containing aluminum; an insulator covering one surface of said plate; and a heating circuit carried by said insulator, wherein said insulator comprises an anodized oxide layer having a thickness between 10 and 200 microns and resistant to abrupt temperature variations of said plate.

2. The heating element of claim 1 wherein said plate is made of pure aluminum or aluminum alloyed with silicon or magnesium.

3. The heating element of claim I wherein said oxide layer has a composition of a layer obtained by an anodic oxidation conducted in a solution of an acid of low electric conductivity, with a current density between 1 and 5 A/dm² at a stabilized temperature.

4. The heating element of claim 3 wherein said oxide layer has pores, and further comprising a metallic oxide filling said pores.

5. The heating element of claim 4 wherein said metallic oxide is produced by decomposition of a polymerizable organometallic product.

6. The heating element of claim 5 wherein the polymerizable organometallic product is a silane, or an organic derivative of titanium, or of zirconium, or of germanium, or of tin.

7. The heating element of claim 1 further comprising a glass having a low melting point and impregnating the surface of the oxide layer.

8. The heating element of claim 1 wherein said heating circuit is silkscreened onto said oxide layer.

9. The heating element of claim 1 wherein said heating circuit is composed of a metal that is deposited on said oxide layer by a chemical process.

10. The heating element of claim 1 in combination with an iron soleplate, wherein said substrate is brazed onto a face of said soleplate at a temperature which causes firing of said heating circuit.

11. The heating element of claim 1 wherein said substrate is a soleplate of an iron.

12. The heating element of claim 11 wherein said soleplate is enameled, before said insulator is applied to said substrate, on the face intended to contact with fabrics to be ironed, the enameling being performed at a temperature that stress relieves the metal.
